(19) United States
(12) Patent Application Publication
(10) Pub. No.: US 2024/0292285 A1
(43) Pub. Date: Aug. 29, 2024

(54) Method For Fast Return To Dual Connectivity In MUSIM Devices

(71) Applicant: Nokia Technologies Oy, Espoo (FI)

(72) Inventors: Srinivasan SELVAGANAPATHY, Bangalore (IN); Laura Luque SANCHEZ, Aalborg (DK); Tero HENTTONEN, Espoo (FI)

(21) Appl. No.: 18/583,136

(22) Filed: Feb. 21, 2024

(30) Foreign Application Priority Data
Feb. 28, 2023 (IN) 202341013471

(51) Int. Cl. H04W 36/00; H04W 36/36

(52) U.S. Cl. CPC H04W 36/0069; H04W 36/362

(57) ABSTRACT

An apparatus comprising circuitry configured to: transmit, from a first user equipment connected to a first network, an indication of a capability to delay execution of conditional primary secondary cell addition; transmit, from the first user equipment, assistance information to a network node in the first network, wherein the assistance information comprises at least one of a request for release of a secondary cell group or a fast return indication; and receive, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

### TECHNICAL FIELD

The examples and non-limiting example embodiments relate generally to communications and, more particularly, to a method for fast return to dual connectivity in MUSIM devices.

### BACKGROUND

It is known for a user equipment to operate in dual connectivity in a communication network.

### SUMMARY

In accordance with an aspect, an apparatus includes: at least one processor; and at least one memory storing instructions that, when executed by the at least one processor, cause the apparatus at least to: transmit, from a first user equipment connected to a first network, an indication of at least one capability to the first network, wherein the at least one capability comprises a capability to delay execution of conditional primary secondary cell addition; transmit, from the first user equipment, assistance information to a network node in the first network, wherein the assistance information comprises at least one of a request for release of a secondary cell group or a fast return indication; and receive, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, an apparatus includes: at least one processor; and at least one memory storing instructions that, when executed by the at least one processor, cause the apparatus at least to: receive, from a first user equipment connected to a first network, an indication of at least one capability, wherein the at least one capability comprises a capability to delay execution of conditional primary secondary cell addition; receive, from the first user equipment, assistance information with a network node in the first network, wherein the assistance information comprises at least one of a request for release of a secondary cell group or a fast return indication; and transmit, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, a method includes: transmitting, from a first user equipment connected to a first network, an indication of at least one capability to the first network, wherein the at least one capability comprises a capability to delay execution of conditional primary secondary cell addition; transmitting, from the first user equipment, assistance information to a network node in the first network, wherein the assistance information comprises at least one of a request for release of a secondary cell group or a fast return indication; and receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, a method includes: receiving, from a first user equipment connected to a first network, an indication of at least one capability, wherein the at least one capability comprises a capability to delay execution of conditional primary secondary cell addition; receiving, from the first user equipment, assistance information with a network node in the first network, wherein the assistance information comprises at least one of a request for release of a secondary cell group or a fast return indication; and transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, an apparatus includes: means for transmitting, from a first user equipment connected to a first network, an indication of at least one capability to the first network, wherein the at least one capability comprises a capability to delay execution of conditional primary secondary cell addition; means for transmitting, from the first user equipment, assistance information to a network node in the first network, wherein the assistance information comprises at least one of a request for release of a secondary cell group or a fast return indication; and means for receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, an apparatus includes: means for receiving, from a first user equipment connected to a first network, an indication of at least one capability, wherein the at least one capability comprises a capability to delay execution of conditional primary secondary cell addition; means for receiving, from the first user equipment, assistance information with a network node in the first network, wherein the assistance information comprises at least one of a request for release of a secondary cell group or a fast return indication; and means for transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, a non-transitory program storage device readable by a machine, tangibly embodying a program of instructions executable by the machine for performing operations is provided, the operations including: transmitting, from a first user equipment connected to a first network, an indication of at least one capability to the first network, wherein the at least one capability comprises a capability to delay execution of conditional primary secondary cell addition; transmitting, from the first user equipment, assistance information to a network node in the first network, wherein the assistance information comprises at least one of a request for release of a secondary cell group or a fast return indication; and receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

In accordance with an aspect, a non-transitory program storage device readable by a machine, tangibly embodying a program of instructions executable by the machine for performing operations is provided, the operations including: receiving, from a first user equipment connected to a first network, an indication of at least one capability, wherein the at least one capability comprises a capability to delay execution of conditional primary secondary cell addition; receiving, from the first user equipment, assistance information with a network node in the first network, wherein the assistance information comprises at least one of a request for release of a secondary cell group or a fast return indication; and transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example of a message signaling exchange between a MUSIM UE and two networks, based on the examples described herein.

FIG. 3 is an example apparatus configured to implement the examples described herein.

FIG. 4 shows a representation of an example of non-volatile memory media used to store instructions that implement the examples described herein.

FIG. 5 is an example method implemented with a user equipment, based on the examples described herein.

FIG. 6 is an example method implemented with a network node, based on the examples described herein.

### DETAILED DESCRIPTION OF EXAMPLE EMBODIMENTS

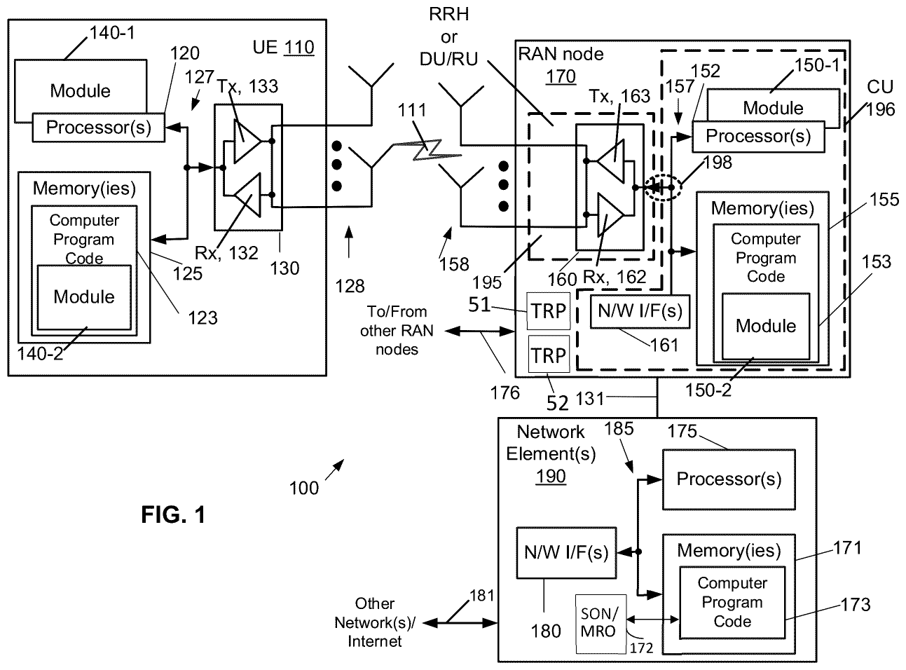

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree Cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including a method for fast return to dual connectivity in MUSIM devices. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The Rel-18 work item for MUSIM enhancements for Dual TX/RX capable UE contains the following objective. Enhancements for MUSIM procedures to operate in RRC_CONNECTED state simultaneously in NW A and NW B. Specify mechanism to indicate preference on temporary UE capability restriction and removal of restriction (e.g. capability update, release of cells, (de) activation of configured resources) with NW A when the UE needs transmission or reception (e.g., start/stop connection to NW B) for MUSIM purposes. RAT Concurrency: Network A is NR SA (with CA) or NR DC. Network B can either be LTE or NR. Applicable UE architecture: Dual-RX/Dual-TX UE.

It has been discussed the possibility for supporting SCG of NW-A in deactivated state when the UE wants to setup RRC connection in NW-B. As part of the discussions several issues have been raised in handling the SCG in deactivated state. The problem and summary of issues discussed is given below.

Scenario. UE 110 has an active connection with DC at NW-A. UE 110 wants to setup connection in NW-B. UE may ask for SCG-Deactivation at NW-A. The NW switches the SCG to SCG-Deactivated state.

Problem. The described scenario leads to UE 110 having configuration for 3 different CGs at the same time: 1) MCG (NW-A): Active, 2) SCG (NW-A): Inactive, 3) RRC Connection (NW-B): Active.

Issues. The above configuration may exceed UE capability. Even though one of the SCGs is in deactivated state, the UE may need to maintain the configuration alive. The UE may need to perform some activities related to the SCG in DEACTIVATED state (RLM, measurements). If the UE capability does not allow SCG to be maintained in DEACTIVATED state, an alternative solution is needed to maintain the configuration in NW-A in standby to allow fast switching to dual connectivity at NW-A. Described herein is one solution in this regard.

Conditional resume for CA/DC involves a set of rules/conditions for the UE to conditionally resume a CA/DC upon transition to connected mode in where the conditions are provided before the UE moves to idle/inactive.That allows a UE to resume RRC connection and directly evaluate the conditions for CA/DC. The UE stores conditional configuration when leaving the RRC connection and this configuration can be used when the UE resumes the RRC connection from RRC-INACTIVE state. Even though conditional configurations are stored at UE 110 when it releases the connection partially, it continues with RRC connection with NW-A and can evaluate the measurement-ID for conditional execution. The method described herein relates to UE capability and a method to handle the CPA configuration received when the NW-B connection is active and delay the execution until the release of NW-B. Further described herein is a UE indication for a fast return and NW request for CPA status on return to handle the configurations.

As described herein, the fast return is meant as a method to quickly return to dual connectivity instead of doing the legacy, and more time consuming, process to add an SCG to be in Dual connectivity. The fast-return=‘Yes” as described herein is a possibility provided in which the UE may inform the network about the capability of doing “fast-return”, meaning that the UE can get a CPA configuration and delay the evaluation until the connection with NW-B is released.

Described herein is a signaling procedure that enables a MUSIM UE capable of dual TX/RX, that is requesting SCG release at NW-A for short RRC connection at NW-B, to resume back to dual connectivity when the UE does not support maintaining SCG of NW-A in deactivated state in MUSIM operation.

The following is the proposed signaling steps of the invention.

### NW Configuration of CPA in Response to UAI for SCG Release Request

A MUSIM UE operates with dual connectivity at NW-A. The UE sends UAI (UE assistance information) indicating the release of SCG with the additional flag ‘Fast resume’ to an MN.

The MN sends an RRC Reconfiguration message containing SCG-Release including one or more conditional configurations for CPA. Such conditional configuration includes the target configuration corresponding to the current SCG and/or other target SCGs which are suitable for CPA based on the latest measurement results.

The MN decision to send the CPA configuration in response to the UE request for SCG-Release for MUSIM operation may be based on a UE capability that the UE can delay the CPA execution until the resources required for CPA configuration is released from NW-B. The UE indicates the ‘delayed evaluation of CPA until removal of restriction for SCG’ as a UE capability to allow the MN to configure CPA in response to UAI for SCG-Release.

In an example embodiment, the CPA configuration may contain a list of target cells and conditions for connection to those target cells. As part of the CPA configuration in this scenario, the NW may also indicate to the UE to send a ‘removal of restriction’ message if the UE does not find any prepared target cells suitable for CPA execution on return after the UE evaluates CPA conditions. Based on this message the NW can release the CPA configurations within the network. This message can be considered as a ‘CPA status’ indication on return.

### UE Action on Receiving RRC Reconfiguration with CPA on SCG Release Along with Optional Flag for ‘CPA-status-Indication’

UE 110 will delay the evaluation of CPA conditions until release of NW-B resources. On release of NW-B resources UE 110 starts CPA evaluation.

If CPA evaluation is successful within a configured timer duration, the CPA configuration is executed and the UE resumes dual connectivity at NW-A.

If the CPA condition is not met within the configured time, UE 110 sends UAI for release of restriction and, optionally, latest measurement results on the SCG layer. This enables the MN to decide on release of CPA or execute the best target configuration based on the received measurement results.

### Certain Embodiments Propose

A method where the UE can delay the CPA evaluation for NW-A for as long as it has active RRC connection at NW-B. This can be indicated as UE capability to NW-A.

A method where, upon UE transmission of UAI for SCG release, including indication of ‘fast return’, which means that the UE is capable of delayed CPA evaluation, the MN configures the UE with a CPA configuration along with SCG-Release.

A method where the MN also configures the UE to report the CPA status on release of NW-B RRC connection.

The status response from the UE may be given using UAI indicating removal of restriction and, optionally, one or more measurement results for CPA target cells.

The message sequence 200 illustrating the herein described method is given in FIG.

2:

1 (201). MUSIM UE with UE-A 110-1 in RRC connection with dual connectivity with NW-A (MN 170-1, SN 170-2) and UE-B 110-2 in RRC Idle with NW-B 170-3.

2 (202). UE-B 110-2 wants to initiate RRC connection with NW-B 170-3.

3 (203). UE-A 110-1 provides UE capabilities to NW-A (including MN 170-1), including capability to delay the execution of CPA during MUSIM operation, e.g. the UE-A 110-1 supports delayed CPA execution during MUSIM operation.

4 (204). As the UE capability does not allow to have more than two active SCG simultaneously, and having SCG in deactivated state is not supported, UE-B 110-2 requests to UE-A 110-1 to release SCG. The arrow at step 4 (204) is for the UE-B 110-2 internally notifying UE-A 110-1 that it (UE-A 110-1) needs to request SCG release to NW-A (including MN 170-1), as it happens in the following step 5 (205).

5 (205). UE-A 110-1 sends UAI to MN 170-1 in NW-A requesting SCG release. This UAI includes a “fast return” indication e.g. Fast-return=‘Yes’. The fast-return=‘Yes” is a possibility in which the UE 110-1 may inform the network (170-1, 170-2) about the capability of doing “fast-return”, meaning that the UE 110-1 can get a CPA configuration and delay the evaluation until the connection with NW-B 170-3 is released. This speeds up the addition of the SCG later, making the return to dual connectivity much faster.

6 (206). In NW-A, MN 170-1 coordinates with SN 170-2 the CPA preparation including the current serving cell and/or other target cells to be included in the CPA configuration.

7 (207). NW-A (MN 170-1) sends an RRC reconfiguration to UE-A 110-1 indicating SCG release and CPA configuration with an optional indication that the conditions for connection to target cells included in the CPA configuration should be evaluated after UE-B 110-2 releases RRC connection with NW-B 170-3. In certain example embodiments, MN 170-1 may indicate to UE-A 110-1 a ‘UAI-For-CPA-Status-on-Return’ indication. In certain example embodiments, the delay of CPA execution (step 12 (212) until receipt of Remove-Restriction (211) is based on receipt of RRCReconfig with SCG-Release and CPAConfig (step 7 (207)) and at least one UE capability. The ‘UAI-For-CPA-Status-on-Return’ relates to a method where the MN also configures the UE to report the CPA status on release of the NW-B RRC connection.

8 (208). In NW-A, MN 170-1 informs SN 170-2 about the SCG release with indication to keep the CPA configuration for later evaluation.

9 (209). UE-B 110-2 proceeds to establish RRC connection with NW-B 170-3.

10 (210). UE-B 110-2 finishes operations with NW-B 170-3 and RRC connection is released.

11 (211). UE-B 110-2 informs UE-A 110-1 about NW-B connection ends and therefore removal of capability restriction.

12 (212). UE-A 110-1 proceeds with the CPA condition evaluation.

Case in which CPA conditions are met, comprising items 214 and 215:

13 (213). Conditions for CPA are met.

14 (214). UE-A 110-1 informs MN 170-1 that the RRC reconfiguration is completed.

15 (215). UE-A 110-1 proceeds with SCG addition to resume the dual connectivity.

Case in which CPA conditions are not met, comprising items 217 and 218:

16 (216). Conditions for CPA are not met.

17 (217). UE-A 110-1 sends UAI to NW-A (including MN 170-1) indicating the restriction removal for SCG. Optionally, UE-A 110-1 can also indicate the last measurement results for the one or more CPA candidate(s).

18 (218). NW-A (including MN 170-1) decides to release the SCG or, if latest measurements (not meeting the conditions) are received from UE-A 110-1, NW-A (including MN 170-1) could decide to configure SCG with the best cell using the received measurement report.

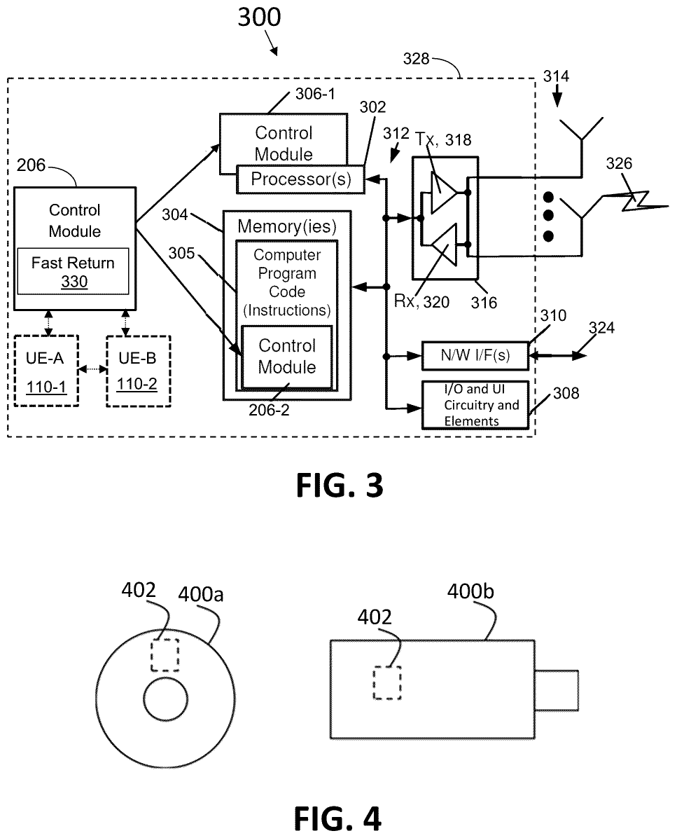

FIG. 3 is an example apparatus 300, which may be implemented in hardware, configured to implement the examples described herein. The apparatus 300 comprises at least one processor 302 (e.g. an FPGA and/or CPU), one or more memories 304 including computer program code 305, the computer program code 305 having instructions to carry out the methods described herein, wherein the at least one memory 304 and the computer program code 305 are configured to, with the at least one processor 302, cause the apparatus 300 to implement circuitry, a process, component, module, or function (implemented with control module 306) to implement the examples described herein, including a method for fast return to dual connectivity in MUSIM devices. Fast return 330 of the control module 306 may perform a fast return operation. The memory 304 may be a non-transitory memory, a transitory memory, a volatile memory (e.g. RAM), or a non-volatile memory (e.g. ROM).

The apparatus 300 includes a display and/or I/O interface 308, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 300 includes one or more communication e.g. network (N/W) interfaces (I/F(s)) 310. The communication I/F(s) 310 may be wired and/or wireless and communicate over the Internet/other network(s) via any communication technique including via one or more links 324. The link(s) 324 may be the link(s) 131 and/or 176 from FIG. 1. The link(s) 131 and/or 176 from FIG. 1 may also be implemented using transceiver(s) 316 and corresponding wireless link(s) 326. The communication I/F(s) 310 may comprise one or more transmitters or one or more receivers.

The transceiver 316 comprises one or more transmitters 318 and one or more receivers 320. The transceiver 316 and/or communication I/F(s) 310 may comprise standard well-known components such as an amplifier, filter, frequency-converter, (de) modulator, and encoder/decoder circuitries and one or more antennas, such as antennas 314 used for communication over wireless link 326.

The control module 306 of the apparatus 300 comprises one of or both parts 306-1 and/or 306-2, which may be implemented in a number of ways. The control module 306 may be implemented in hardware as control module 306-1, such as being implemented as part of the one or more processors 302. The control module 306-1 may be implemented also as an integrated circuit or through other hardware such as a programmable gate array. In another example, the control module 306 may be implemented as control module 306-2, which is implemented as computer program code (having corresponding instructions) 305 and is executed by the one or more processors 302. For instance, the one or more memories 304 store instructions that, when executed by the one or more processors 302, cause the apparatus 300 to perform one or more of the operations as described herein. Furthermore, the one or more processors 302, one or more memories 304, and example algorithms (e.g., as flowcharts and/or signaling diagrams), encoded as instructions, programs, or code, are means for causing performance of the operations described herein.

The apparatus 300 to implement the functionality of control 306 may be UE 110, RAN node 170 (e.g. gNB), or network element(s) 190. Thus, processor 302 may correspond to processor(s) 120, processor(s) 152 and/or processor(s) 175, memory 304 may correspond to one or more memories 125, one or more memories 155 and/or one or more memories 171, computer program code 305 may correspond to computer program code 123, computer program code 153, and/or computer program code 173, control module 306 may correspond to module 140-1, module 140-2, module 150-1, and/or module 150-2, and communication I/F(s) 310 and/or transceiver 316 may correspond to transceiver 130, antenna(s) 128, transceiver 160, antenna(s) 158, N/W I/F(s) 161, and/or N/W I/F(s) 180. Alternatively, apparatus 300 and its elements may not correspond to either of UE 110, RAN node 170, or network element(s) 190 and their respective elements, as apparatus 300 may be part of a self-organizing/optimizing network (SON) node or other node, such as a node in a cloud.

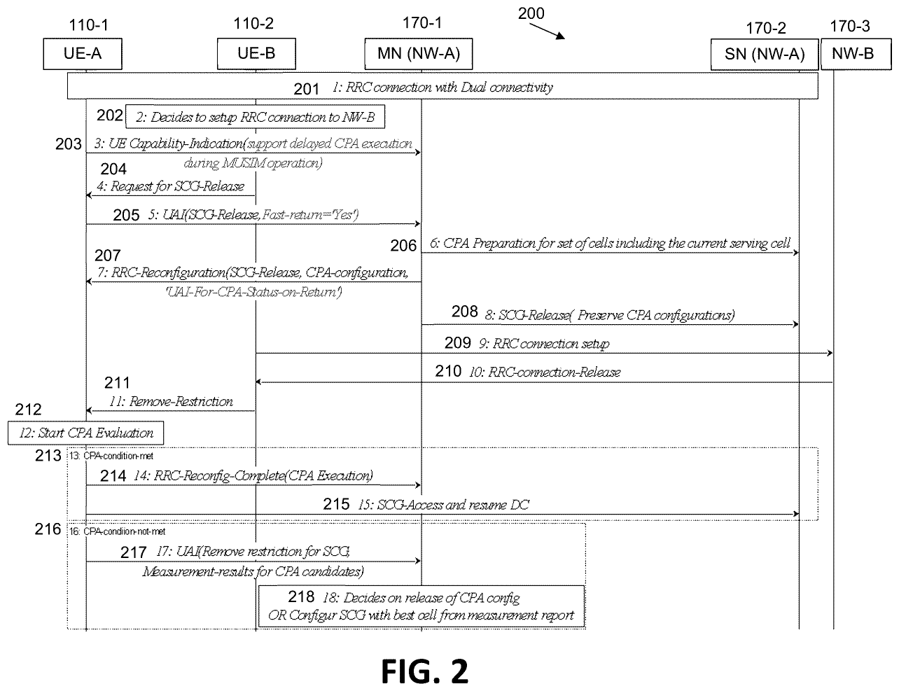

The apparatus 300 may also be distributed throughout the network (e.g. 100) including within and between apparatus 300 and any network element (such as a network control element (NCE) 190 and/or the RAN node 170 and/or the UE 110). Apparatus 300 may correspond to any of the network nodes depicted in FIG. 2, including UE-A 110-1, UE-B 110-2, MN 170-1, SN 170-2, or NW-B 170-3. As shown in FIG. 3, apparatus 300 optionally comprises UE-A 110-1 and UE-B 110-2, thus apparatus 300 may correspond to a multi universal subscriber identity module apparatus comprising UE-A 110-1 and UE-B 110-2.

Interface 312 enables data communication and signaling between the various items of apparatus 300, as shown in FIG. 3. For example, the interface 312 may be one or more buses such as address, data, or control buses, and may include any interconnection mechanism, such as a series of lines on a motherboard or integrated circuit, fiber optics or other optical communication equipment, and the like. Computer program code (e.g. instructions) 305, including control 306 may comprise object-oriented software configured to pass data or messages between objects within computer program code 305. The apparatus 300 need not comprise each of the features mentioned, or may comprise other features as well. The various components of apparatus 300 may at least partially reside in a common housing 328, or a subset of the various components of apparatus 300 may at least partially be located in different housings, which different housings may include housing 328.

FIG. 4 shows a schematic representation of non-volatile memory media 400a (e.g. computer/compact disc (CD) or digital versatile disc (DVD)) and 400b (e.g. universal serial bus (USB) memory stick) storing instructions and/or parameters 402 which when executed by a processor allows the processor to perform one or more of the steps of the methods described herein.

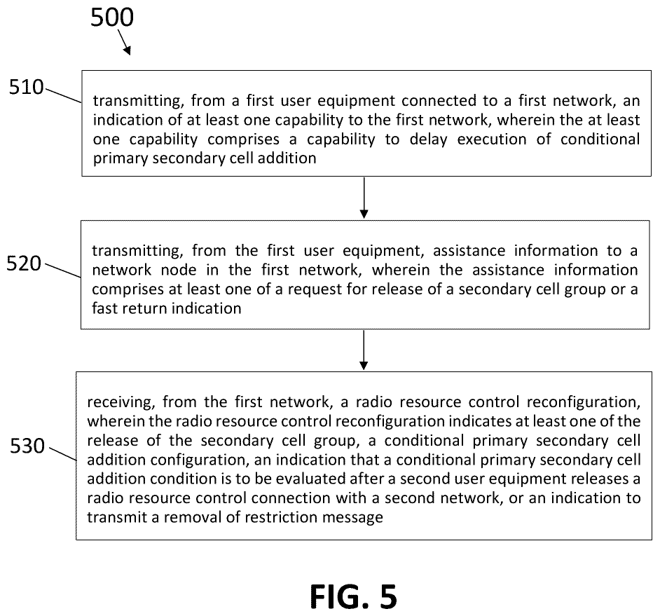

FIG. 5 is an example method 500 performed with a user equipment, based on the example embodiments described herein. At 510, the method includes transmitting, from a first user equipment connected to a first network, an indication of at least one capability to the first network, wherein the at least one capability comprises a capability to delay execution of conditional primary secondary cell addition. At 520, the method includes transmitting, from the first user equipment, assistance information to a network node in the first network, wherein the assistance information comprises at least one of a request for release of a secondary cell group or a fast return indication. At 530, the method includes receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message. Method 500 may be performed with UE 110, UE-A 110-1, or apparatus 300.

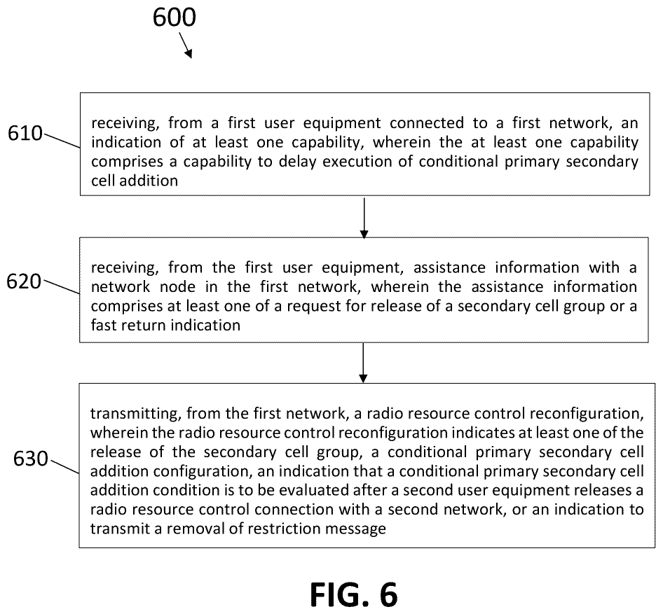

FIG. 6 is an example method 600 performed with a network node, based on the example embodiments described herein. At 610, the method includes receiving, from a first user equipment connected to a first network, an indication of at least one capability, wherein the at least one capability comprises a capability to delay execution of conditional primary secondary cell addition. At 620, the method includes receiving, from the first user equipment, assistance information with a network node in the first network, wherein the assistance information comprises at least one of a request for release of a secondary cell group or a fast return indication. At 630, the method includes transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message. Method 600 may be performed with RAN node 170, NW-A (170-1, 170-2), MN 170-1, or apparatus 300.

The following examples are provided and described herein.

Example 1. An apparatus including: at least one processor; and at least one memory storing instructions that, when executed by the at least one processor, cause the apparatus at least to: transmit, from a first user equipment connected to a first network, an indication of at least one capability to the first network, wherein the at least one capability comprises a capability to delay execution of conditional primary secondary cell addition; transmit, from the first user equipment, assistance information to a network node in the first network, wherein the assistance information comprises at least one of a request for release of a secondary cell group or a fast return indication; and receive, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 2. The apparatus of example 1, wherein the apparatus comprises a multi universal subscriber identity module apparatus comprising the first user equipment and the second user equipment.

Example 3. The apparatus of example 2, wherein the apparatus does not support maintaining the secondary cell group of the first network in deactivated state in presence of the radio resource control connection with the second network; wherein the apparatus not supporting maintaining the secondary cell group of the first network in deactivated state is due to the apparatus not having such capability, or due to a current configuration exceeding the capability of the apparatus.

Example 4. The apparatus of any of examples 1 to 3, wherein the instructions, when executed by the at least one processor, cause the apparatus at least to: transmit, to the first network, a removal of restriction message when the first user equipment does not locate at least one prepared target cell suitable for execution of conditional primary secondary cell addition.

Example 5. The apparatus of example 4, wherein the removal of restriction message is configured to cause release of at least one conditional primary secondary cell addition configuration.

Example 6. The apparatus of any of examples 1 to 5, wherein the instructions, when executed by the at least one processor, cause the apparatus at least to: delay evaluation of at least one conditional primary secondary cell addition condition until release of at least one resource of the second network; and start evaluation of the at least one conditional primary secondary cell addition condition, upon release of the at least one resource of the second network.

Example 7. The apparatus of example 6, wherein the instructions, when executed by the at least one processor, cause the apparatus at least to: execute the conditional primary secondary cell addition configuration and resume dual connectivity with the first network, when the at least one condition related to at least one conditional primary secondary cell addition target cell is met within a configured timer duration.

Example 8. The apparatus of any of examples 6 to 7, wherein the instructions, when executed by the at least one processor, cause the apparatus at least to: transmit second assistance information that indicates a request for release of the secondary cell group, when the at least one condition related to at least one conditional primary secondary cell addition target cell is not met within a configured time.

Example 9. The apparatus of example 8, wherein the instructions, when executed by the at least one processor, cause the apparatus at least to: transmit at least one measurement result performed on the secondary cell group.

Example 10. The apparatus of example 9, wherein the at least one measurement result is configured to cause the network node to determine whether to release the conditional primary secondary cell addition configuration or to configure the secondary cell group with a cell.

Example 11. An apparatus including: at least one processor; and at least one memory storing instructions that, when executed by the at least one processor, cause the apparatus at least to: receive, from a first user equipment connected to a first network, an indication of at least one capability, wherein the at least one capability comprises a capability to delay execution of conditional primary secondary cell addition; receive, from the first user equipment, assistance information with a network node in the first network, wherein the assistance information comprises at least one of a request for release of a secondary cell group or a fast return indication; and transmit, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 12. The apparatus of example 11, wherein the first user equipment is comprised in a multi universal subscriber identity module apparatus comprising the first user equipment and the second user equipment.

Example 13. The apparatus of example 12, wherein the multi universal subscriber identity module apparatus does not support maintaining the secondary cell group of the first network in deactivated state in presence of the radio resource control connection with the second network; wherein the multi universal subscriber identity module apparatus not supporting maintaining the secondary cell group of the first network in deactivated state is due to the multi universal subscriber identity module apparatus not having such capability, or due to a current configuration exceeding the capability of the multi universal subscriber identity module apparatus.

Example 14. The apparatus of any of examples 11 to 13, wherein the instructions, when executed by the at least one processor, cause the apparatus at least to: receive, from the first user equipment, a removal of restriction message when the first user equipment does not locate at least one prepared target cell suitable for execution of conditional primary secondary cell addition.

Example 15. The apparatus of example 14, wherein the instructions, when executed by the at least one processor, cause the apparatus at least to: release at least one conditional primary secondary cell addition configuration, based on the removal of restriction message.

Example 16. The apparatus of any of examples 11 to 15, wherein the indication of the at least one capability relates to: delayed evaluation of at least one conditional primary secondary cell addition condition until release of at least one resource of the second network; and starting evaluation of the at least one conditional primary secondary cell addition condition, upon release of the at least one resource of the second network.

Example 17. The apparatus of example 16, wherein the conditional primary secondary cell addition configuration causes the first user equipment to execute the conditional primary secondary cell addition configuration and resume dual connectivity with the first network, when the at least one condition related to at least one conditional primary secondary cell addition target cell is met within a configured timer duration.

Example 18. The apparatus of any of examples 16 to 17, wherein the instructions, when executed by the at least one processor, cause the apparatus at least to: receive second assistance information that indicates a request for release of the secondary cell group, when the at least one condition related to at least one conditional primary secondary cell addition target cell is not met within a configured time.

Example 19. The apparatus of example 18, wherein the instructions, when executed by the at least one processor, cause the apparatus at least to: receive at least one measurement result performed on the secondary cell group.

Example 20. The apparatus of example 19, wherein the instructions, when executed by the at least one processor, cause the apparatus at least to: determine whether to release the conditional primary secondary cell addition configuration or configure the secondary cell group with a cell, based on the at least one measurement result.

Example 21. A method including: transmitting, from a first user equipment connected to a first network, an indication of at least one capability to the first network, wherein the at least one capability comprises a capability to delay execution of conditional primary secondary cell addition; transmitting, from the first user equipment, assistance information to a network node in the first network, wherein the assistance information comprises at least one of a request for release of a secondary cell group or a fast return indication; and receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 22. A method including: receiving, from a first user equipment connected to a first network, an indication of at least one capability, wherein the at least one capability comprises a capability to delay execution of conditional primary secondary cell addition; receiving, from the first user equipment, assistance information with a network node in the first network, wherein the assistance information comprises at least one of a request for release of a secondary cell group or a fast return indication; and transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 23. An apparatus including: means for transmitting, from a first user equipment connected to a first network, an indication of at least one capability to the first network, wherein the at least one capability comprises a capability to delay execution of conditional primary secondary cell addition; means for transmitting, from the first user equipment, assistance information to a network node in the first network, wherein the assistance information comprises at least one of a request for release of a secondary cell group or a fast return indication; and means for receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 24. An apparatus including: means for receiving, from a first user equipment connected to a first network, an indication of at least one capability, wherein the at least one capability comprises a capability to delay execution of conditional primary secondary cell addition; means for receiving, from the first user equipment, assistance information with a network node in the first network, wherein the assistance information comprises at least one of a request for release of a secondary cell group or a fast return indication; and means for transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 25. A non-transitory program storage device readable by a machine, tangibly embodying a program of instructions executable by the machine for performing operations, the operations including: transmitting, from a first user equipment connected to a first network, an indication of at least one capability to the first network, wherein the at least one capability comprises a capability to delay execution of conditional primary secondary cell addition; transmitting, from the first user equipment, assistance information to a network node in the first network, wherein the assistance information comprises at least one of a request for release of a secondary cell group or a fast return indication; and receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

Example 26. A non-transitory program storage device readable by a machine, tangibly embodying a program of instructions executable by the machine for performing operations, the operations including: receiving, from a first user equipment connected to a first network, an indication of at least one capability, wherein the at least one capability comprises a capability to delay execution of conditional primary secondary cell addition; receiving, from the first user equipment, assistance information with a network node in the first network, wherein the assistance information comprises at least one of a request for release of a secondary cell group or a fast return indication; and transmitting, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, lines and arrows between individual blocks represent operational couplings there-between, and arrows represent the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number):
4G fourth generation
5G fifth generation
5GC 5G core network
AMF access and mobility management function
ASIC application-specific integrated circuit
CA carrier aggregation
CD compact/computer disc
CG configured grant
CPA conditional PSCell addition
CPU central processing unit
CU central unit or centralized unit
DC dual connectivity
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
gNB base station for 5G/NR, i.e., a node providing NR user plane and control plane protocol terminations towards the UE, and connected via the NG interface to the 5GC
IAB integrated access and backhaul
I/F interface
I/O input/output
LMF location management function
LTE long term evolution (4G)
MAC medium access control
MCG master cell group
MN master node
MME mobility management entity
MR mixed reality
MRO mobility robustness optimization
MUSIM multi universal subscriber identity module
NB Node B
NCE network control element
ng or NG new generation
ng-eNB new generation eNB
NG-RAN new generation radio access network
NR new radio
N/W network
NW network
PDA personal digital assistant
PDCP packet data convergence protocol
PHY physical layer
PSCell primary secondary cell
RAM random access memory
RAN radio access network
RAT radio access technology
Reconfig reconfiguration
Rel release
RLC radio link control
RLM radio link monitoring
ROM read-only memory
RRC radio resource control
RU radio unit
Rx or RX receiver or reception
SA standalone
SCG secondary cell group
SGW serving gateway
SMF session management function
SN secondary node
SON self-organizing/optimizing network
TRP transmission reception point
Tx or TX transmitter or transmission
UAI UE assistance information
UAV unmanned aerial vehicle
UE user equipment (e.g., a wireless, typically mobile device)
UI user interface
UMTS universal mobile telecommunications system
UPF user plane function
USB universal serial bus
UTRA UMTS terrestrial radio access
UTRAN UMTS terrestrial radio access network
X2 network interface between RAN nodes and between RAN and the core network
Xn network interface between NG-RAN nodes

We claim:

1. An apparatus, comprising:
at least one processor; and
at least one memory storing instructions that, when executed by the at least one processor, cause the apparatus at least to:
transmit, from a first user equipment connected to a first network, an indication of at least one capability to the first network, wherein the at least one capability comprises a capability to delay execution of conditional primary secondary cell addition;
transmit, from the first user equipment, assistance information to a network node in the first network, wherein the assistance information comprises at least one of a request for release of a secondary cell group or a fast return indication; and
receive, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

2. The apparatus of claim 1, wherein the apparatus comprises a multi universal subscriber identity module apparatus comprising the first user equipment and the second user equipment.

3. The apparatus of claim 2, wherein the apparatus does not support maintaining the secondary cell group of the first network in deactivated state in presence of the radio resource control connection with the second network.

4. The apparatus of claim 1, wherein the instructions, when executed by the at least one processor, cause the apparatus at least to:
transmit, to the first network, a removal of restriction message when the first user equipment does not locate at least one prepared target cell suitable for execution of conditional primary secondary cell addition.

5. The apparatus of claim 4, wherein the removal of restriction message is configured to cause release of at least one conditional primary secondary cell addition configuration.

6. The apparatus of claim 1, wherein the instructions, when executed by the at least one processor, cause the apparatus at least to:
delay evaluation of at least one conditional primary secondary cell addition condition until release of at least one resource of the second network; and
start evaluation of the at least one conditional primary secondary cell addition condition, upon release of the at least one resource of the second network.

7. The apparatus of claim 6, wherein the instructions, when executed by the at least one processor, cause the apparatus at least to:
execute the conditional primary secondary cell addition configuration and resume dual connectivity with the first network, when the at least one condition related to at least one conditional primary secondary cell addition target cell is met within a configured timer duration.

8. The apparatus of claim 6, wherein the instructions, when executed by the at least one processor, cause the apparatus at least to:
transmit second assistance information that indicates a request for release of the secondary cell group, when the at least one condition related to at least one conditional primary secondary cell addition target cell is not met within a configured time.

9. The apparatus of claim 8, wherein the instructions, when executed by the at least one processor, cause the apparatus at least to:
transmit at least one measurement result performed on the secondary cell group.

10. The apparatus of claim 9, wherein the at least one measurement result is configured to cause the network node to determine whether to release the conditional primary secondary cell addition configuration or to configure the secondary cell group with a cell.

11. An apparatus, comprising:
at least one processor; and
at least one memory storing instructions that, when executed by the at least one processor, cause the apparatus at least to:
receive, from a first user equipment connected to a first network, an indication of at least one capability, wherein the at least one capability comprises a capability to delay execution of conditional primary secondary cell addition;
receive, from the first user equipment, assistance information with a network node in the first network, wherein the assistance information comprises at least one of a request for release of a secondary cell group or a fast return indication; and
transmit, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.

12. The apparatus of claim 11, wherein the first user equipment is comprised in a multi universal subscriber identity module apparatus comprising the first user equipment and the second user equipment.

13. The apparatus of claim 12, wherein the multi universal subscriber identity module apparatus does not support maintaining the secondary cell group of the first network in deactivated state in presence of the radio resource control connection with the second network.

14. The apparatus of claim 11, wherein the instructions, when executed by the at least one processor, cause the apparatus at least to:
receive, from the first user equipment, a removal of restriction message when the first user equipment does not locate at least one prepared target cell suitable for execution of conditional primary secondary cell addition.

15. The apparatus of claim 14, wherein the instructions, when executed by the at least one processor, cause the apparatus at least to:
release at least one conditional primary secondary cell addition configuration, based on the removal of restriction message.

16. The apparatus of claim 11, wherein the indication of the at least one capability relates to:
delayed evaluation of at least one conditional primary secondary cell addition condition until release of at least one resource of the second network; and
starting evaluation of the at least one conditional primary secondary cell addition condition, upon release of the at least one resource of the second network.

17. The apparatus of claim 16, wherein the conditional primary secondary cell addition configuration causes the first user equipment to execute the conditional primary secondary cell addition configuration and resume dual connectivity with the first network, when the at least one condition related to at least one conditional primary secondary cell addition target cell is met within a configured timer duration.

18. The apparatus of claim 16, wherein the instructions, when executed by the at least one processor, cause the apparatus at least to:
receive second assistance information that indicates a request for release of the secondary cell group, when the at least one condition related to at least one conditional primary secondary cell addition target cell is not met within a configured time.

19. The apparatus of claim 18, wherein the instructions, when executed by the at least one processor, cause the apparatus at least to:
receive at least one measurement result performed on the secondary cell group.

20. The apparatus of claim 19, wherein the instructions, when executed by the at least one processor, cause the apparatus at least to:
determine whether to release the conditional primary secondary cell addition configuration or configure the secondary cell group with a cell, based on the at least one measurement result.

21. A method, comprising:
transmitting, from a first user equipment connected to a first network, an indication of at least one capability to the first network, wherein the at least one capability comprises a capability to delay execution of conditional primary secondary cell addition;
transmitting, from the first user equipment, assistance information to a network node in the first network, wherein the assistance information comprises at least one of a request for release of a secondary cell group or a fast return indication; and
receiving, from the first network, a radio resource control reconfiguration, wherein the radio resource control reconfiguration indicates at least one of the release of the secondary cell group, a conditional primary secondary cell addition configuration, an indication that a conditional primary secondary cell addition condition is to be evaluated after a second user equipment releases a radio resource control connection with a second network, or an indication to transmit a removal of restriction message.
